(19) United States
(12) Patent Application Publication
(10) Pub. No.: US 2007/0070442 A1
(43) Pub. Date: Mar. 29, 2007

(54) Image reading device, image processing device, image reading method, and image processing method

(75) Inventor: Hiroshi Ohkubo, Ebina-shi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/400,287

(22) Filed: Apr. 10, 2006

(30) Foreign Application Priority Data
Sep. 21, 2005 (JP) 2005-274438

(51) Int. Cl. H04N 1/393

(52) U.S. Cl. 358/451; 358/474

(57) ABSTRACT

An aspect of the invention provides an image reading device, comprising: an image reading unit that reads input images and digitizes the input images; a parameter designating unit; an image reducing unit; a pre-combine thumbnail image generating unit an N-up image generating unit; an N-up thumbnail image generating unit; and a storage device that stores (1) the N-up image generated, (2) the N-up thumbnail image, (3) the N-number of pre-combine thumbnail images corresponding to the N-number of pre-combine reduced images included in the N-up image, and (4) layout information that indicates a layout of the pre-combine reduced images in the N-up image and is defined.

### BACKGROUND

1. Technical Field

The present invention relates to technologies for allowing images combined after being reduced to be edited in image reading devices that reduce, and subsequently combine, the images of multiple pages that are read, and store these.

2. Related Art

The falling costs of hard disk drives (HDD), for example, has lead to the development of image reading devices such as scanners and multi function devices that have large capacity storage devices. Such image reading devices store images that are read out (scanned) on a storage device such as a HDD, and can output these when the need arises.

To increase the number of pages of images that are stored in the image reading devices, in addition to increasing the size of their storage devices, a technology for collecting multiple pages (N pages) of images into a single page that is then stored is developed. Hereinafter, the operation of reducing and then combining N pages of images to generate a single image page will be referred to as “N-up.” Further, images that are N-upped will be referred to as “N-up images.” To set the images that are read out and the N-up images to the same page size, the images that are read out are reduced according to the value of N. For example, if N=2, then the reduction ratio is 0.71, and if N=4, then the reduction ratio is 0.5. The pages of images are first reduced in size and then combined into a single image. It is these N-up images of reduced then combined images that are stored in the storage device, and the pages of original images (those before reduction) are not stored in the storage device. For this reason, there was the problem that with such image reading devices it was not possible to edit and search the pages of original images.

### SUMMARY

An aspect of the invention provides an image reading device, including: an image reading unit that reads input images and digitizes the input images, the input images including a plurality of pages, the plurality of pages being digitized one by one; a parameter designating unit that designates a parameter that defines a reduction ratio a (where a is a positive real number), a parameter that defines a number N for combining the reduced images, and a parameter that defines a layout of the reduced images; an image reducing unit that generates pre-combine reduced images, the pre-combine reduced images being generated by reducing the input images in accordance with the reduction ratio a designated by the parameter designating unit; a pre-combine thumbnail image generating unit that generates pre-combine thumbnail images, the pre-combine thumbnail images being generated by reducing the input images in accordance with a reduction ratio b (where b is a positive real number, and satisfies a>b); an N-up image generating unit that generates an N-up image, the N-up image being generated by combining N-number of the pre-combine reduced images, the N-number of the pre-combine reduced images being combined in a layout defined by the parameters, the parameters being designated by the parameter designating unit;

an N-up thumbnail image generating unit that generates an N-up thumbnail image, the N-up thumbnail image being generated by reducing the N-up image in accordance with a reduction ratio c (where c is a positive real number, and satisfies a>c); and a storage device that stores (1) the N-up image generated by the N-up image generating unit, (2) the N-up thumbnail image corresponding to the N-up image, generated by the N-up thumbnail image generating unit, (3) the N-number of pre-combine thumbnail images corresponding to the N-number of pre-combine reduced images included in the N-up image, generated by the pre-combine thumbnail image generating unit, and (4) layout information that indicates a layout of the pre-combine reduced images in the N-up image and is defined by the parameter designating unit.

### BRIEF DESCRIPTION OF THE DRAWINGS

Embodiments of the present invention will be described in detail based on the following figures, wherein:

FIG. 1 is a block diagram showing the configuration of the multi function device 100 according to an embodiment of the invention;

FIG. 2 is a flowchart showing the process of reading (scanning) N-up images;

FIG. 3 is a diagram for describing the data that are stored in the HDD 138;

FIG. 4 is a diagram showing an example of the UI 136;

FIG. 5 is a diagram showing an example of the display screen of the N-up thumbnail images;

FIG. 6 is a diagram showing another example of the editing screen of the pre-combine thumbnail images;

FIG. 7A is a flowchart showing the processing on the thumbnail display screen;

FIG. 7B is a flowchart showing the processing on the thumbnail display screen;

FIG. 8 is a diagram showing an example of the thumbnail editing screen 30 for the page switching process;

FIG. 9 is a diagram showing an example of the thumbnail editing screen 30 for the N-changing process;

FIG. 10 is a diagram showing an example of the thumbnail editing screen 30 for the masking process;

FIG. 11 is a diagram showing an example of the thumbnail editing screen 30 for masking removal;

FIG. 12 is a diagram showing an example of the thumbnail editing screen 30 for the blank page adding process;

FIG. 13 is a diagram showing an example of the thumbnail editing screen 30 for the page deletion process; and

FIG. 14 is a diagram showing an example of the operation screen according to another embodiment.

### DETAILED DESCRIPTION

An embodiment of the invention is described below with reference to the drawings.

### 1. Reading the N-up Image

First, the operation of reading original images (or input images) to generate data for an N-up image is described.

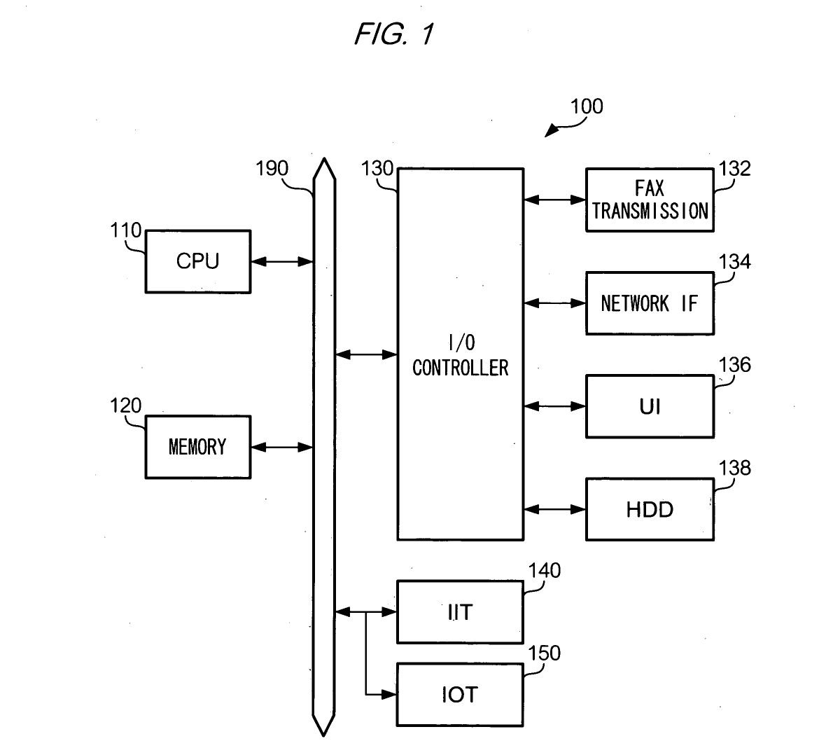

FIG. 1 is a block diagram showing a configuration of a multi function device 100 according to an embodiment of the invention. The multi function device 100 is an image reading device and an image forming device having functions of printer, scanner, FAX, and copier. A CPU (central processing unit) 110 controls the various elements of the multi function device 100. A memory 120 includes a RAM (random access memory) and a ROM (read-only memory). An I/O controller 130 has the function of controlling the input and output of data and control signals to and from the multi function device 100. A FAX communication unit 132 is a module for sending and receiving FAX transmissions. A network IF 134 is an interface for sending and receiving data over a network. A UI 136 is a user interface for the user to input commands to the multi function device 100. The UI 136 includes a liquid crystal display, touch panel, and ten-key number pad, for example. A HDD (hard disk drive) 138 is a storage device for storing various programs and image data, for example. An IIT (image input terminal) 140 is a module for reading (or inputting) images. An IOT (image output terminal) 150 is a module for forming (or outputting) images. The above elements are connected to one another through a bus 190.

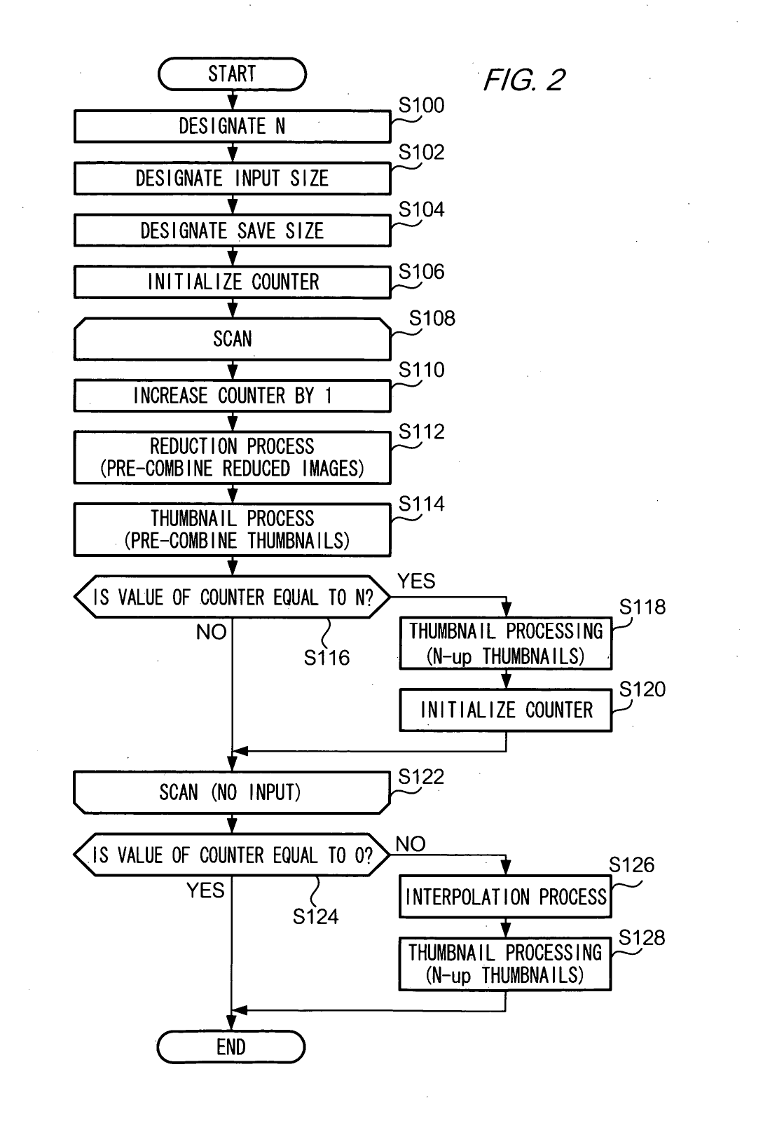

FIG. 2 is a flowchart showing a process for reading (or scanning) N-up images. The CPU 110 reads an image reading program for executing the reading of images from the memory 120 or the HDD 138, and executes this program, executing the processing shown in FIG. 2

The user inputs a value for the parameter N through the UI 136 to use in the process for generating the N-up image data (step S100). Next, the user inputs the size of the original document images, that is, the input size, through the UI 136 (step S102). The user also inputs the size of the saved (or stored) image when saving the images as data, that is, the save size, through the UI 136 (step S104). It is to be noted that the input size may be automatically detected by the multi function device 100. Further, there is no limitation to FIG. 2 regarding the order in which the processes of steps S100 to S104 are performed, and this order can be freely changed.

Next, the CPU 110 initializes the value of the counter to 0 (step S106). The CPU 110 controls IIT 140 to scan one page of the original document image and generates data (step S108). When scanning the original document, the multi function device 100 carries the original document to a reading position one page at a time by an ADF (automatic document feeder; not shown in the figures) and reads the document one page at a time, in other words, reads the document one page by one page. The CPU 110 updates the value of the count, increasing it by one (step S110). The CPU 110 reduces the digitized image to obtain a pre-combine reduced image (step S112). The reduction ratio for the reduction process is defined as below based on the input size, the save size, and the N′ (N) determined by the value of N. It is to be noted that the value of N′ may be, for example, N′(2)=0.7, N′(4)=0.5, or N′(8)=0.35.
reduction ratio=save size/input size*N′(N).

Next, the CPU 110 performs a thumbnail process to generate a thumbnail of the one page of the original document image (pre-combine thumbnail image) (step S114). The CPU 110 adds property information including an identifier for specifying the original document image and a page number of the original document image to the pre-combine thumbnail image that is generated. The reduction ratio when generating the thumbnail is determined in advance, and for example is 1/100. The reduction ratio for generating the thumbnail may be smaller than that for generating the pre-combine reduced image. The CPU 110 stores the pre-combine thumbnail image that is generated in the memory 120.

Next, the CPU 110 determines whether the counter value equals N (step S116). If the counter equals N (step S116: YES), then the CPU 110 advances the procedure to step S118. If the counter does not equal N (step S116: NO), then the CPU 110 repeatedly executes the processing of steps S108 to S114 until the condition “no input (of scanned image)” is satisfied. When the condition “no input” is satisfied, the CPU 110 advances the procedure to step S124.

In step S118, the CPU 110 performs thumbnail processing. That is, the CPU 110 combines (or synthesizes) the pre-combine reduced images of the N-number of pages to obtain an N-up image. The layout (or arrangement) of the pre-combine reduced images in the N-up image is designated by the parameter designating module (or parameter designating unit). For example, in the case of a 4-up image (N=4), the image of the first page is positioned (or laid-out) on the upper left, the image of the second page is positioned on the upper right, the image of the third page is positioned on the lower left, and the image of the fourth page is positioned on the lower right. Alternatively, it is also possible that, as designated by the parameter designating unit, the image of the first page is positioned on the upper right, the image of the second page is positioned on the upper left, the image of the third page is positioned on the lower right, and the image of the fourth page is positioned on the lower left. The CPU 110 adds property information to the generated N-up image. The property information includes an identifier for specifying that N-up image and a page number of the N-up images. The CPU 110 then generates a thumbnail image of the N-up image, that is N-up thumbnail image. The CPU 110 adds property information to the N-up thumbnail image that is generated. The property information includes an identifier for specifying that N-up thumbnail image, the page number of the N-up thumbnail image, an identifier for specifying the pre-combine thumbnail images corresponding to that N-up thumbnail image, and layout information that indicates the layout of the pre-combine reduced images in the N-up image. The reduction ratio when generating the thumbnail images of the N-up images is determined in advance. The reduction ratio for generating the thumbnail images may be smaller than that for the pre-combine reduced images. The reduction ratio of the pre-combine thumbnail images and the reduction ratio of the N-up thumbnail images may be the same or different.

Next, the CPU 110 stores the N-up image, the N-up thumbnail image that corresponds to the N-up image, and the pre-combine thumbnail images (for N-number of pages) of the pre-combine reduced images corresponding to the N-up image, in the HDD 138 in association with one another. When the images are stored in the HDD 138, the CPU 110 resets the counter (step S120).

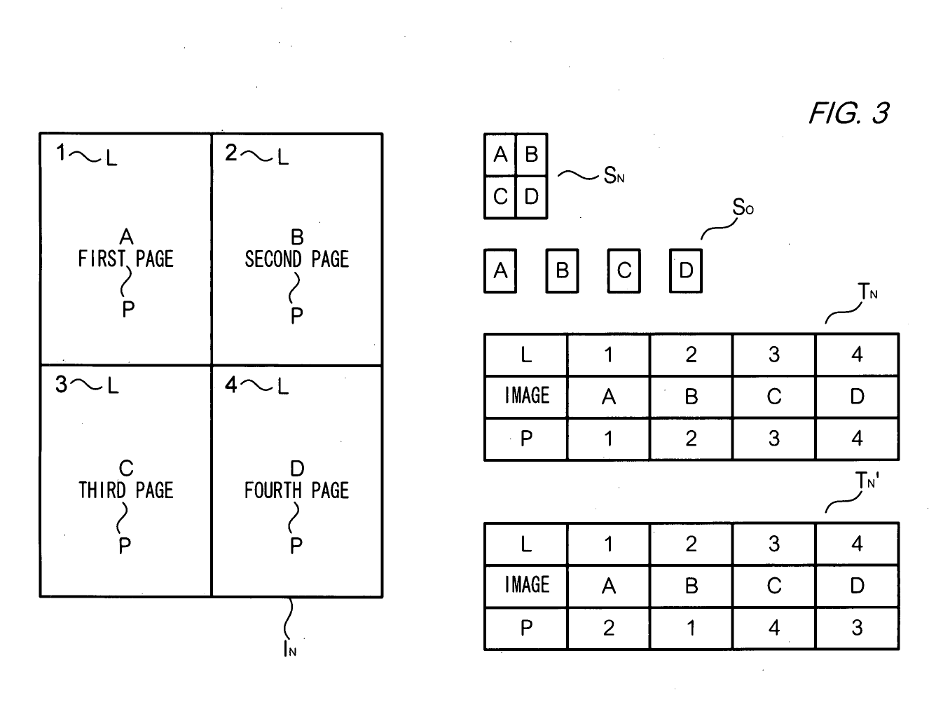

FIG. 3 is a diagram for describing the data that are stored in the HDD 138. FIG. 3 shows an example with N=4. The N-up image IN, the N-up thumbnail image SN, the four pages of pre-combine thumbnail images SO, and the page numbers P of the images before combining are associated with one another, and are saved as one data group (or a data set). The property information of the N-up thumbnail image includes layout information TN. L is layout information that indicates the layout of the images in the N-up image. It is to be noted that in FIG. 3 TN′ corresponds to another embodiment in which the layout of the pre-combine reduced images is different from that of TN.

The description will be continued with reference to FIG. 2. In step S124, the CPU 110 determines whether the counter value equals 0. If the counter value equals 0 (step S124: YES), then the CPU 110 terminates the procedure. If the counter value does not equal 0 (step S124: NO), then the CPU 110 advances the procedure to step S126.

In step S126, the CPU 110 performs interpolation. Interpolation is performed with respect to blank regions (regions where a page does not exist) in a case where the page number of the page that is scanned in is not a multiple of N. For example, the pixel value of the blank region is set to a value of 0 in a case of the color space of the image data is a CMYK system, or 255 in a case of an RGB system. The CPU 110 then executes thumbnail processing similarly to in step S128. When thumbnail processing is over, the CPU 110 terminates the procedure.

### 2. Displaying Thumbnail Images

The operation of displaying N-up image data on the UI 136 is discussed below.

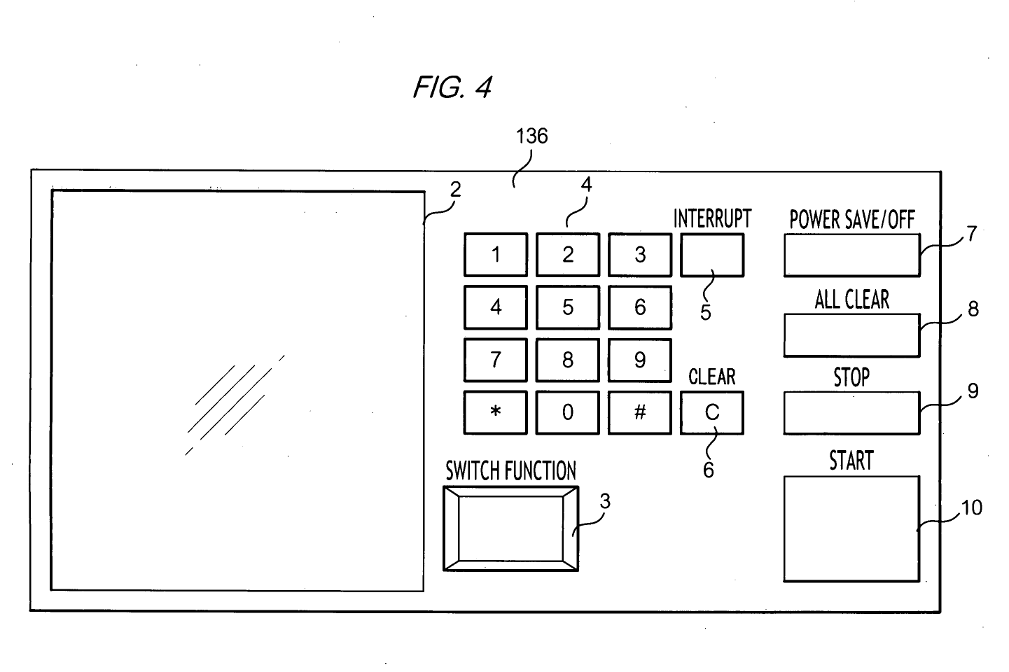

FIG. 4 illustratively shows the UI 136. A liquid crystal touch panel 2 includes an LCD (liquid crystal display) and a touch panel. The liquid crystal touch panel 2 displays the image to be processed, or an image or characters indicating how the processing is proceeding, for example. When the user touches the liquid crystal touch panel 2, the CPU 110 performs processing corresponding to the image displayed at the position that the user touched. A function switch key 3 is a button for switching the function of the multi function device 100 to a thumbnail image display, copier, FAX, or scanner, for example. A ten-key touch pad 4 is for inputting numbers. A clear key 6 is a key for canceling information being input. A power save key 7 is a key for switching the operating mode of the multi function device 100 between a power save mode and a normal mode. A clear all key 8 is a key for reverting the values of set parameters to their default values. A stop key 9 is a key for stopping the processing being executed. A start key 10 is a key for starting processing.

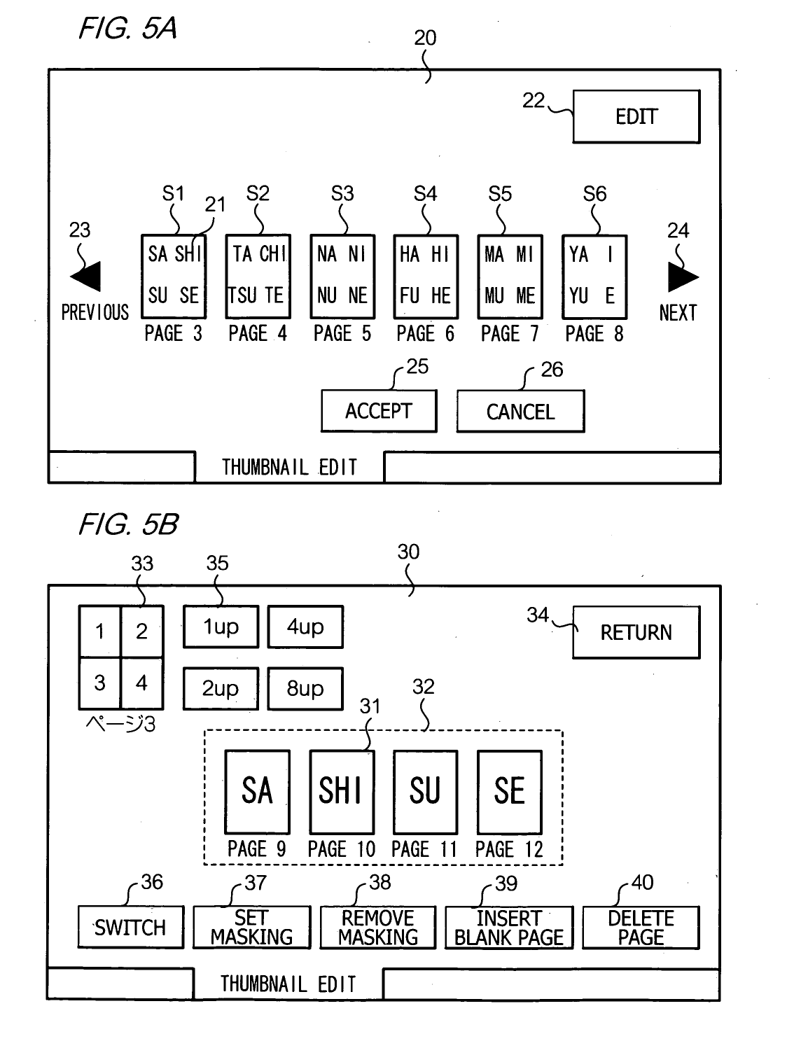

FIG. 5A is illustratively shows the display screen of an N-up thumbnail image. When the user actuates the function switch key 3 to specify that the thumbnail images are displayed, the CPU 110 displays the thumbnail display screen 20 shown in FIG. 5A on the liquid crystal touch panel 2. The thumbnail display screen 20 displays a predetermined number of N-up thumbnail images. In the example of FIG. 5A, six pages of N-up thumbnail images, from page 3 to page 8, are displayed. The memory 120 stores the identifiers specifying the N-up thumbnail images to be shown. The CPU 110 displays the N-up thumbnail images specified by the identifiers on the thumbnail display screen 20. It is to be noted that in FIG. 5A, N=4. The N-up thumbnail images initially shown on the thumbnail display screen 20 may be determined in advance (for example, pages 1 to 6). Alternatively, the N-up thumbnail images initially shown on the thumbnail display screen 20 may be the N-up thumbnail images that were displayed previously. The previous N-up thumbnail images may be stored in the HDD 138.

A move key 23 is a key for changing the N-up thumbnail images that are displayed on the thumbnail display screen 20. When the user touches the position of the move key 23, the CPU 110 reduces the page number of the N-up thumbnail images to be displayed one number at a time. In the example of FIG. 5A, when the user touches the position of the move key 23, the CPU 110 changes (or updates) the N-up thumbnail images that are displayed to the images of page 2 to page 7. Likewise, a move key 24 is a key for increasing the page number of the N-up thumbnail images to be displayed one number at a time. Displayed below the N-up thumbnail images is the information that indicates the page number. The page number is included in the property information of the N-up thumbnail images. In this embodiment, identifiers are added to the N-up thumbnail images in order from the left in FIG. 5A in the manner of S1, S2, etc.

FIG. 5B illustratively shows the edit screen for the pre-combine thumbnail images. When the user selects one N-up thumbnail image through an action (or operation) such as touching the position of one of the N-up thumbnail images that are displayed on the thumbnail display screen 20, the CPU 110 displays the thumbnail edit screen 30 shown in FIG. 5B on the liquid crystal touch panel 2. On the thumbnail edit screen 30, the pre-combine thumbnail images 31 corresponding to the N-up thumbnail image that is selected (in the example of FIG. 5B, the N-up thumbnail image of page 3, which includes the four pages “sa,” “shi,” “su,” and “se”) are displayed. That is, when one N-up thumbnail image is selected, the CPU 110 reads the pre-combine thumbnail images of the N pages corresponding to that N-up thumbnail image from the HDD 138. The CPU 110 displays the pre-combine thumbnail images that are read out on the thumbnail edit screen 30. In the example of FIG. 5B, four pages of pre-combine thumbnail images “sa,” “shi,” “su,” and “se” are displayed. Of the property information of those pre-combine thumbnail images, the page numbers are displayed below the pre-combine thumbnail images.

A region line 32 is a border line for separating the pre-combine thumbnail images that correspond to the N-up thumbnail image that is selected, and the pre-combine thumbnail images that correspond to other N-up thumbnail images. Layout information 33 (which corresponds to the page position information L in FIG. 3) is information that indicates where the pre-combine reduced images are disposed in the N-up image. In the example of FIG. 5B, the layout information 33 shows that these are arranged in the N-up image in the order of upper left, upper right, lower left, and lower right in order from the pre-combine thumbnail image displayed on the left in the region encircled by the region line 32. A return key 34 is a key for returning the procedure to the previous screen. An N-up setting key 35 is a key for changing the N value of the N-up. A switch key 36 is a key for switching the pages. A mask setting key 37 is a key for performing a masking process. A mask cancel key 38 is a key for canceling masking. A blank page insert key 39 is a key for inserting a blank page. A page delete key 40 is a key for executing a page delete process. It is to be noted that these processes are described in detail below.

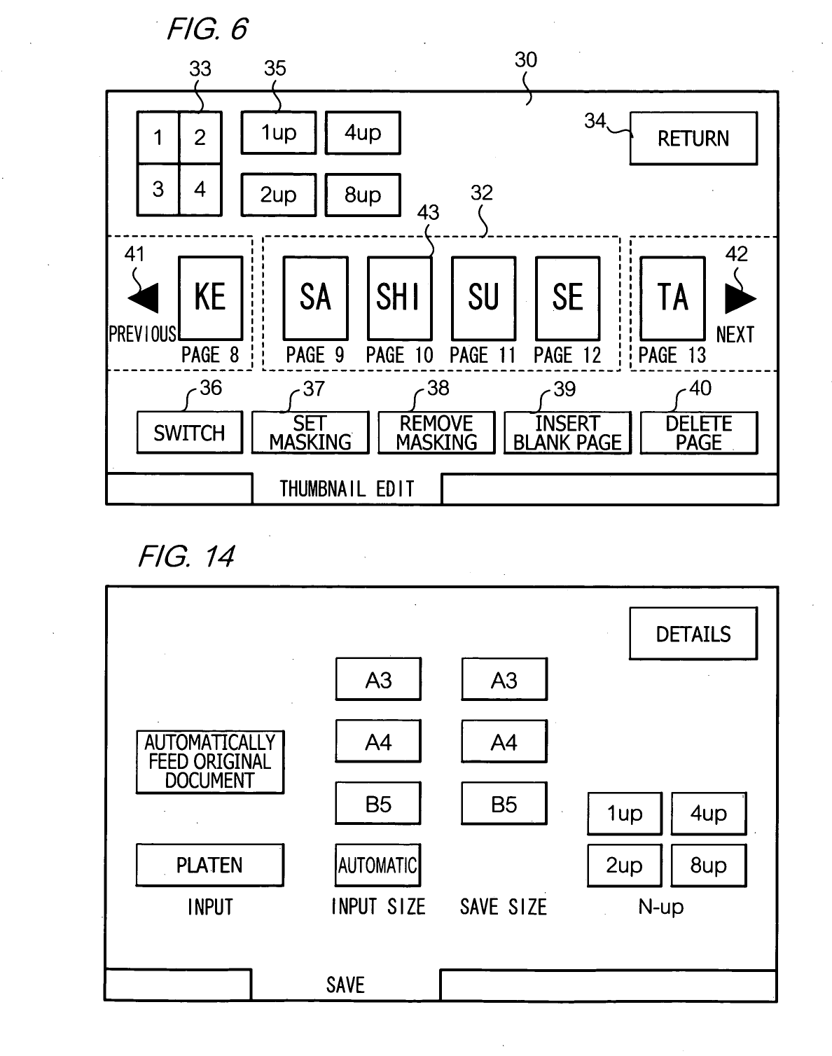

FIG. 6 shows another example of the edit screen for the pre-combine thumbnail images. In the N-up thumbnail image display screen of FIG. 5A, when a user touches the position of the edit key 22, the CPU 110 displays the edit screen shown in FIG. 6 on the liquid crystal touch panel 2. The edit screen of FIG. 6 differs from the edit screen of FIG. 5B in that the pre-combine thumbnail images that are displayed are restricted to those corresponding to a specific N-up thumbnail image that is selected. That is, the edit screen of FIG. 6 displays a predetermined number (six in the case of FIG. 6) of pre-combine thumbnail images. When display of pre-combine thumbnail images is started, the pre-combine thumbnail images that are initially displayed on the thumbnail edit screen 30 are determined based on the N-up thumbnail image that was displayed on the thumbnail display screen 20 when the user touched the edit key 22. For example, the pre-combine thumbnail images corresponding to the N-up thumbnail image displayed furthest left on the thumbnail display screen 20 when the edit key 22 was pressed is displayed. Alternatively, the pre-combine thumbnail images that are initially displayed on the thumbnail edit screen 30 may be determined in advance (for example, from page 1 to page 6). Further, the HDD 138 may store the identifiers of the pre-combine thumbnail images that were displayed previously. The CPU 110 may display the previous pre-combine thumbnail images.

Displaying the pre-combine thumbnail images in this way allows the user to search for a desired N-up thumbnail image with ease.

### 3. Editing the N-up Images

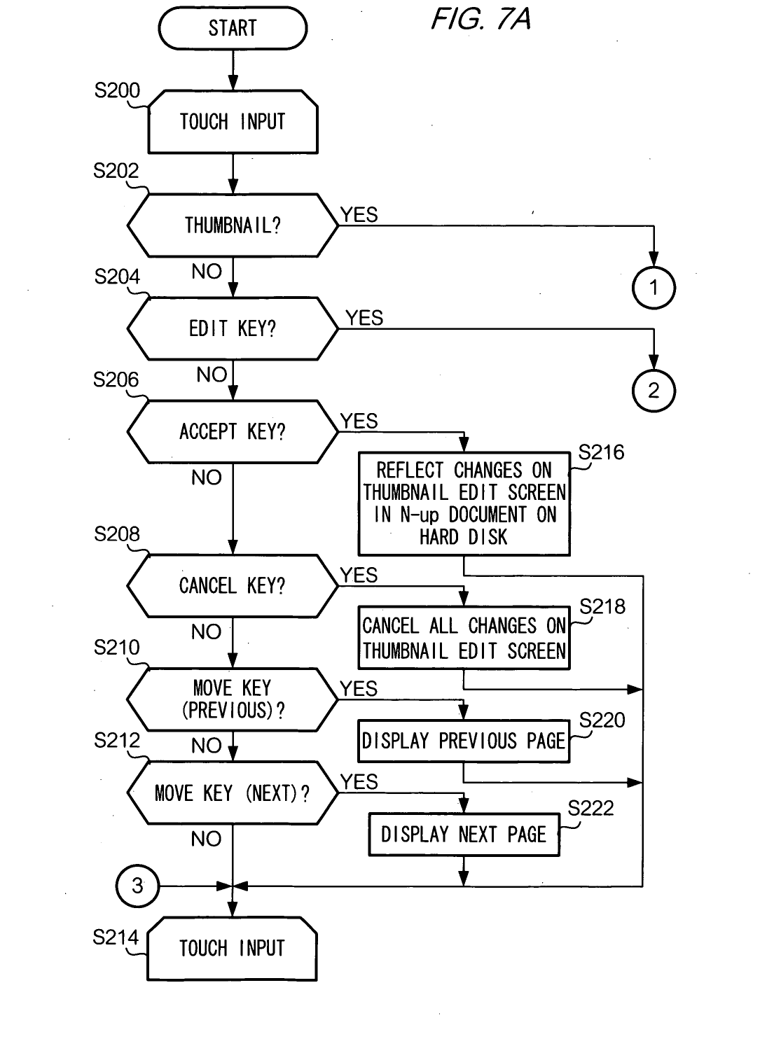

FIG. 7A is a flowchart showing the procedure on the thumbnail display screen. The CPU 110 is on standby for input from the touch panel (step S200). The following procedure performed by the CPU 110 is in correspondence with input from the touch panel. When the position where the N-up thumbnail image displayed on the thumbnail display screen 20 is touched (step S202: YES), the CPU 110 advances the procedure to step S224. In step S224, the CPU 110 displays the thumbnail edit screen 30 shown in FIG. 5B on the liquid crystal touch panel 2. When the position where the edit key 22 is displayed on the thumbnail display screen 20 is touched (step S204: YES), the CPU 110 advances the procedure to step S226. In step S226, the CPU 110 displays the thumbnail edit screen 30 that is displayed in FIG. 6 on the liquid crystal touch panel 2. When the position where the accept key 25 is displayed on the thumbnail display screen 20 is touched (step S206: YES), the CPU 110 advances the procedure to step S216. In step S216, the CPU 110 updates the content stored in the HDD 138 to reflect the data that have changed in thumbnail edit screen 30. When the position where the cancel key is displayed on the thumbnail display screen 20 is touched (step S208: YES), the CPU 110 advances the procedure to step S218. In step S218, the CPU 110 cancels the changes made to the data in the thumbnail edit screen 30 to return to the condition before these changes were made. When the position where the move key 23 is displayed on the thumbnail display screen 20 is touched (step S210: YES), the CPU 110 advances the procedure to step S220. In step S220, the CPU 110 reduces the page numbers of the N-up thumbnail images to be displayed one number at a time. When the position where the move key 24 is displayed on the thumbnail display screen 20 is touched (step S212: YES), the CPU 110 advances the procedure to step S222. In step S222, the CPU 110 increases the page numbers of the N-up thumbnail images to be displayed one number at a time.

FIG. 7B is a flowchart showing the procedure on the thumbnail edit screen. When the thumbnail edit screen 30 of FIG. 5B or FIG. 6 is displayed, the CPU 110 enters a state of standby for input from the touch panel (step S228). The CPU 110 executes processing that is in accordance with the operation of the user to the touch panel. When the position where the switch key 36 is displayed on the thumbnail edit screen 30 is touched (step S230: YES), the CPU 110 executes a switching process (step S244). When the position where the N-up setting key 35 is displayed is touched (step S232: YES), the CPU 110 executes a process to change the N-up number (step S246). When the position where the mask setting key 37 is displayed is touched (step S234: YES), the CPU 110 executes a mask setting process (step S248). When the position where the remove masking key 38 is displayed is touched (step S236: YES), the CPU 110 execute a process for removing the masking (step S250). When the position where the blank page insert key 39 is displayed is touched (step S238: YES), the CPU 110 executes a process for inserting a blank page (step S252). When the position where the page delete key 40 is displayed is touched (step S240: YES), the CPU 110 executes a page delete process (step S254). When the position where the return key 34 is displayed is touched (step S242: YES), the CPU 110 displays the thumbnail display screen 20 on the liquid crystal touch panel 2 and advances the procedure to step S200. These processes are described in further detail below.

3-1. Page Switching Process

When the position where the switch key 36 is displayed on the thumbnail edit screen 30 shown in FIG. 6, for example, is touched, the CPU 110 enters a standby state for input of a pre-combine thumbnail image to be switched. The user selects pre-combine thumbnail images to be switched by touching the positions where the pre-combine thumbnail images to be switched are displayed in order. The CPU 110 adds flags to the two pre-combine thumbnail images that are selected to identify that they are to be switched. The CPU 110 switches the property information pertaining to the page number, of the property information of the two pre-combine thumbnail images that are flagged to indicate that they are to be subjected to switching. The CPU 110 updates the display of the thumbnail edit screen 30 according to the switched property information.

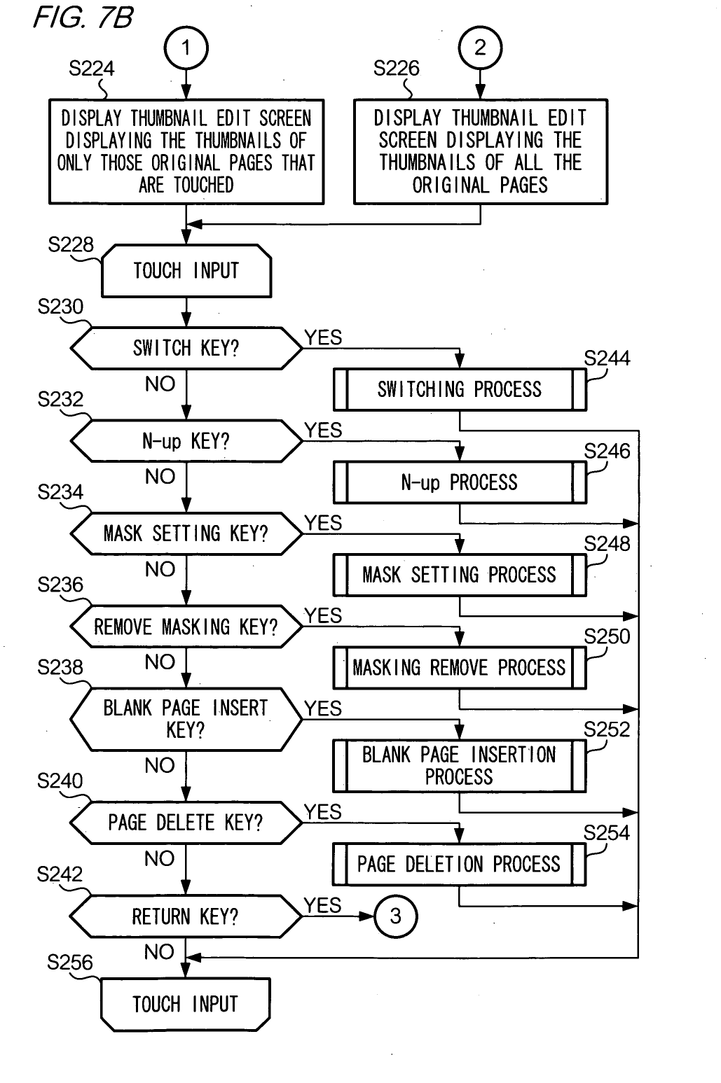

FIG. 8A shows an example of the thumbnail edit screen 30 for the page switching process. The example of FIG. 8A shows a case where the pre-combine thumbnail image of page 9 (“sa”) and the pre-combine thumbnail image of page 13 (“ta”) are selected for switching. That is, the CPU 110 updates the property information relating to the page information, of the property information of the pre-combine thumbnail image “sa,” from “page 9” to “page 13.” The CPU 110 also updates the property information relating to the page information, of the property information of the pre-combine thumbnail image “ta,” from “page 13” to “page 9.” The CPU 110 changes the property information of the pre-combine thumbnail image “sa” that pertains to the corresponding N-up thumbnail image from thumbnail image S1 to thumbnail image S2. Similarly, the CPU 110 changes the property information of the pre-combine thumbnail image “ta” that pertains to the corresponding N-up thumbnail image from thumbnail image S2 to thumbnail image S1. The CPU 110 also exchanges the layout information of the pre-combine thumbnail images “sa” and “ta” in the N-up thumbnail image. It is to be noted that a change history may be stored in the memory 120 so that the changes can be returned to their original condition in step S218.

When the property information of the pre-combine thumbnail images is updated, the CPU 110 updates the N-up image and the N-up thumbnail image according to the updated property information of the pre-combine thumbnail images. The pre-combine thumbnail images corresponding to the N-up thumbnail image S1 are changed to “ta,” “shi,” “su,” and “se” in that order from the upper left. The pre-combine thumbnail image corresponding to the N-up thumbnail image S2 are changed to “sa,” “chi,” tsu,” and “te” in that order from the upper left. The CPU 110 first updates the N-up images corresponding to the N-up thumbnail images that are changed. That is, the CPU 110 divides the N-up image into N partitions (or portions) in accordance with the layout information. The CPU 110 then rearranges the divided images according to the property information. The CPU 110 combines the rearranged images to generate an N-up image. The CPU 110 generates an N-thumbnail image from the N-up image.

FIG. 8B shows an example of the thumbnail display screen 20 for the page switching process. When the user touches the position on the thumbnail edit screen 30 where the return key 34 is displayed, the CPU 110 displays the updated N-up thumbnail images on the thumbnail display screen 20. When the user touches the position on the thumbnail display screen 20 where the cancel key 26 is displayed, the CPU 110 returns the changes to their original condition according to the change history stored in the memory 120. When the user touches the position on the thumbnail display screen 20 where the accept key 25 is displayed, the CPU 110 accepts the changes. That is, CPU 110 stores the changed N-up images, the N-up thumbnail images, and the property information of the N-up thumbnail images in the HDD 138.

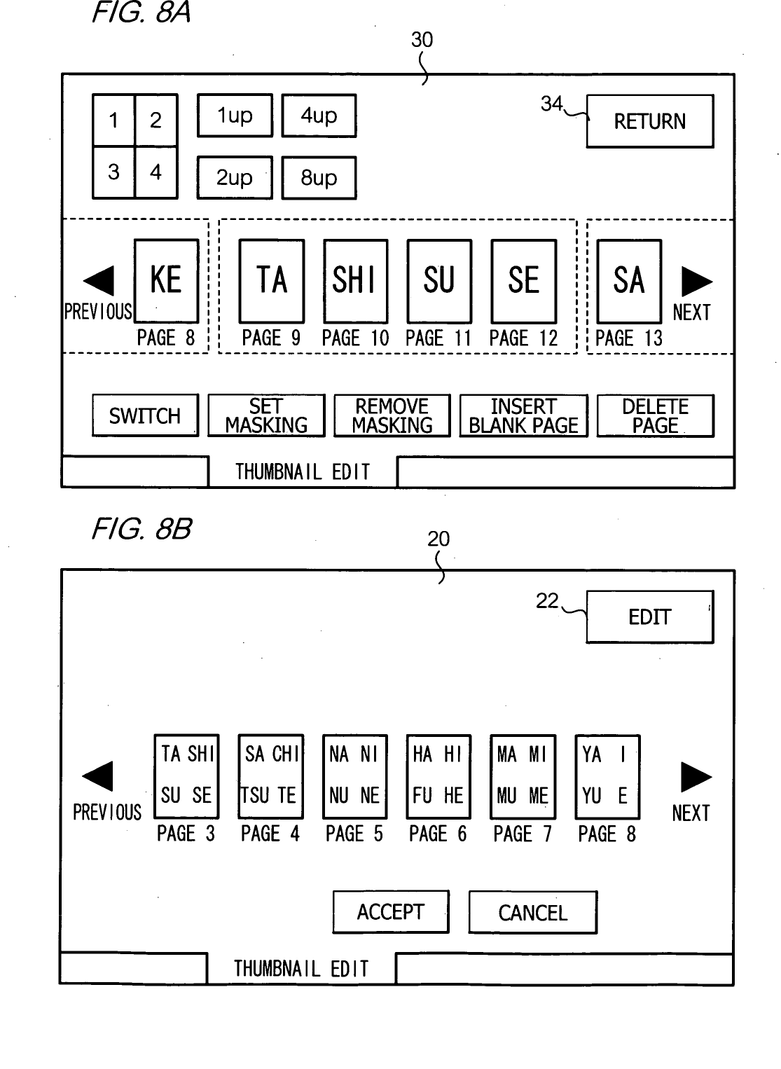

Alternatively, when the position where the return 34 is displayed in FIG. 8A is touched, the thumbnail display screen 20 may be displayed without reflecting the changes made on the thumbnail edit screen 30. In this case, when the user touches the position on the thumbnail display screen 20 where the accept key is displayed, the editing made on the thumbnail edit screen 30 is reflected. When the user touches the position on the thumbnail display screen 20 where the cancel key is displayed, the editing that is performed on the thumbnail edit screen 30 is cancelled. It is to be noted that this processing is the same in FIG. 9B through FIG. 13B.

3-2. N Change Process

FIG. 9A shows an example of the thumbnail edit screen 30 for changing N. When the position on the thumbnail edit screen 30 shown in FIG. 6, for example, where the N-up setting key 35 is displayed is touched, the CPU 110 rearranges the N-up image. If, for example, “2-up,” that is, N=2, is designated in the thumbnail edit screen 30 shown in FIG. 6, then the CPU 110 first reallocates the identifiers specifying the N-up thumbnail images according to the designated parameter N. The CPU 110 allocates new N-up thumbnail images identifiers to the pre-combine thumbnail images two at a time in order from the lowest page number. For example, the CPU 110 assigns the N-up thumbnail image identifier S1 to the pre-combine thumbnail images “sa” and “shi,” assigns the N-up thumbnail image identifier S2 to the pre-combine thumbnail images “su” and “se,” and assigns the N-up thumbnail image identifier S3 to the pre-combine thumbnail images “ta” and “chi.”

When the property information of the pre-combine thumbnail images is updated, the CPU 110 updates the N-up images and the N-up thumbnail images according to the updated property information of the pre-combine thumbnail images. The pre-combine thumbnail images corresponding to the N-up thumbnail image identifier S1 are updated to “sa” and “shi” in that order from the left. The pre-combine thumbnail images corresponding to the N-up thumbnail image identifier S2 are updated to “su” and “se” in that order from the left. Similar operation may be applied for the other N-up thumbnail images. The CPU 110 first updates the N-up image corresponding to the N-up thumbnail image to which a change is made. That is, the CPU 110 divides the N-up image into N partitions based on the layout information. The CPU 110 then rearranges the divided images according to the property information. The CPU 110 then combines the rearranged images to generate the N-up image. The CPU 110 generates the N-up thumbnail images from the N-up image. It is to be noted that, for example, if N=4 is changed to N=2, then the images of the pages making up the N-up image are enlarged by a magnitude of 2 times by area, to keep the same save size. To keep the size of the images of the pages the same, the save size area ratio is reduced by ½.

FIG. 9B shows an example of the thumbnail display screen 20 for changing N. When the user touches the position on the thumbnail edit screen 30 where the return key 34 is displayed, the CPU 110 displays the updated N-up thumbnail image that is updated on the thumbnail display screen 20. When the user touches the position on the thumbnail display screen 20 where the cancel key 26 is displayed, the CPU 110 reverts the changes to their original condition according to the change history stored in the memory 120. When the user touches the position on the thumbnail display screen 20 where the accept key 25 is displayed, the CPU 110 accepts the changes. That is, CPU 110 stores the changed N-up image, N-up thumbnail image, and the property information of the N-up thumbnail image in the HDD 138.

3-3. Masking Process

When the position of the mask setting key 37 on the thumbnail edit screen 30 shown in FIG. 6, for example, is touched, the CPU 110 enters standby for the input of pre-combine thumbnail images to be targeted for masking. The user sequentially selects the pre-combine thumbnail images to be targeted for masking by touching the display positions of the pre-combine thumbnail images to be masked. The CPU 110 adds a flag to the property information of the pre-combine thumbnail images that are selected to identify that they are to be masked. The CPU 110 updates the display of the thumbnail edit screen 30 according to the updated property information. The pre-combine thumbnail images that are to be subjected to masking are displayed in a manner that is different than the other thumbnail images.

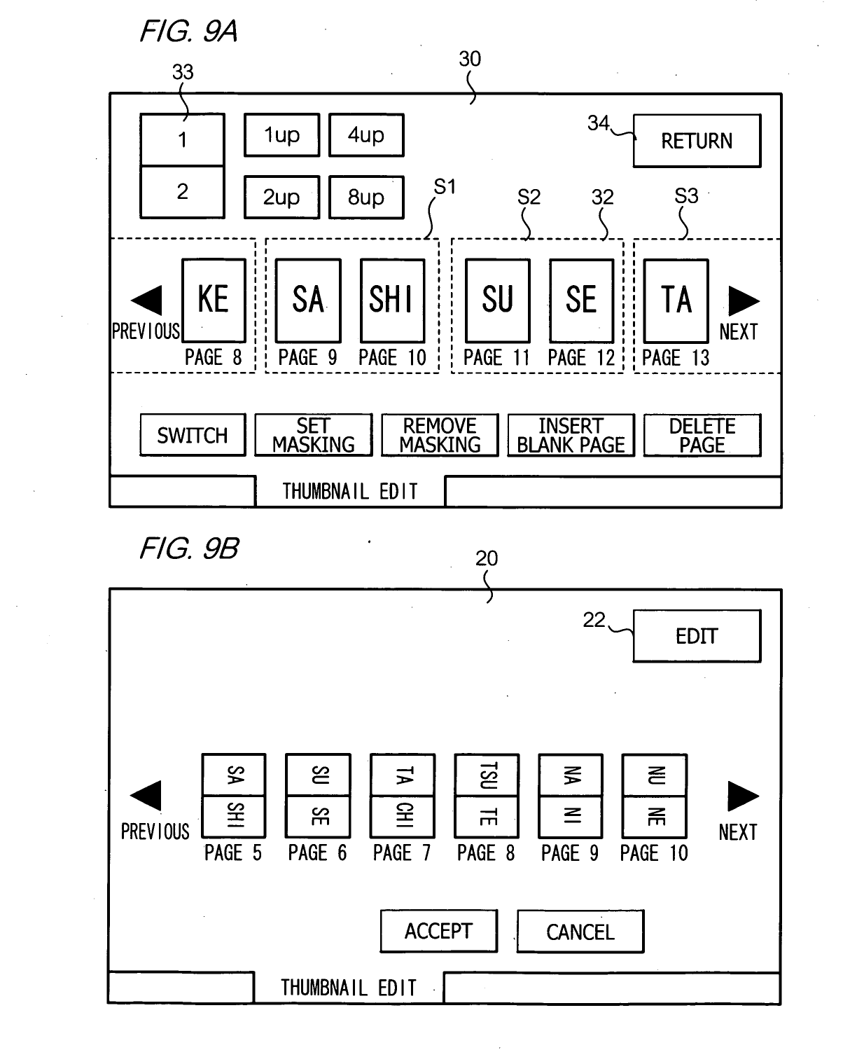

FIG. 10A shows an example of the thumbnail edit screen 30 after designation of the pre-combine thumbnail images to be subjected to masking. In the example of FIG. 10A, an X marking is displayed over the pre-combine thumbnail images to be masked. It is to be noted that the pre-combine thumbnail images to be masked also can be displayed with hatching or in a different color.

When the property information of the pre-combine thumbnail images is updated, the CPU 110 updates the N-up thumbnail images according to the updated property information of the pre-combine thumbnail images. That is, the CPU 110 replaces the portions in the N-up thumbnail images that correspond to the pre-combine thumbnail images that are given a flag to indicate that they are to be subjected to masking with an image that indicates that they are targeted for masking (for example, a solid-white image, image having an X marking, or a hatched image).

FIG. 10B shows an example of the thumbnail display screen 20 for the masking process. When the user touches the position on the thumbnail edit screen 30 where the return key 34 is displayed, the CPU 110 displays the updated N-up thumbnail images on the thumbnail display screen 20. When the user touches the position on the thumbnail display screen 20 where the cancel key 26 is displayed, the CPU 110 reverts the changes to their original condition according to the change history stored in the memory 120. When the user touches the position on the thumbnail display screen 20 where the accept key 25 is displayed, the CPU 110 accepts the changes. That is, CPU 110 stores the changed N-up thumbnail images and the property information of the N-up thumbnail images in the HDD 138.

3-4. Removing Masking

When the user touches the position on the thumbnail edit screen 30 shown in FIG. 6, for example, where the remove masking key 38 is displayed, the CPU 110 enters standby for the input of pre-combine thumbnail images whose masking is to be removed. The user selects pre-combine thumbnail images whose masking is to be removed by touching, in order, the display positions of the pre-combine thumbnail images for which masking removal is to be performed. If flags are added to the property information of the selected pre-combine thumbnail images to identify that they are targeted for masking, then the CPU 110 removes the flags. If a flag to indicate masking is not present, then the CPU 110 displays an error message indicating this on the thumbnail edit screen 30. The CPU 110 updates the display of the thumbnail edit screen 30 according to the updated property information. Those pre-combine thumbnail images targeted for masking removal are then displayed normally.

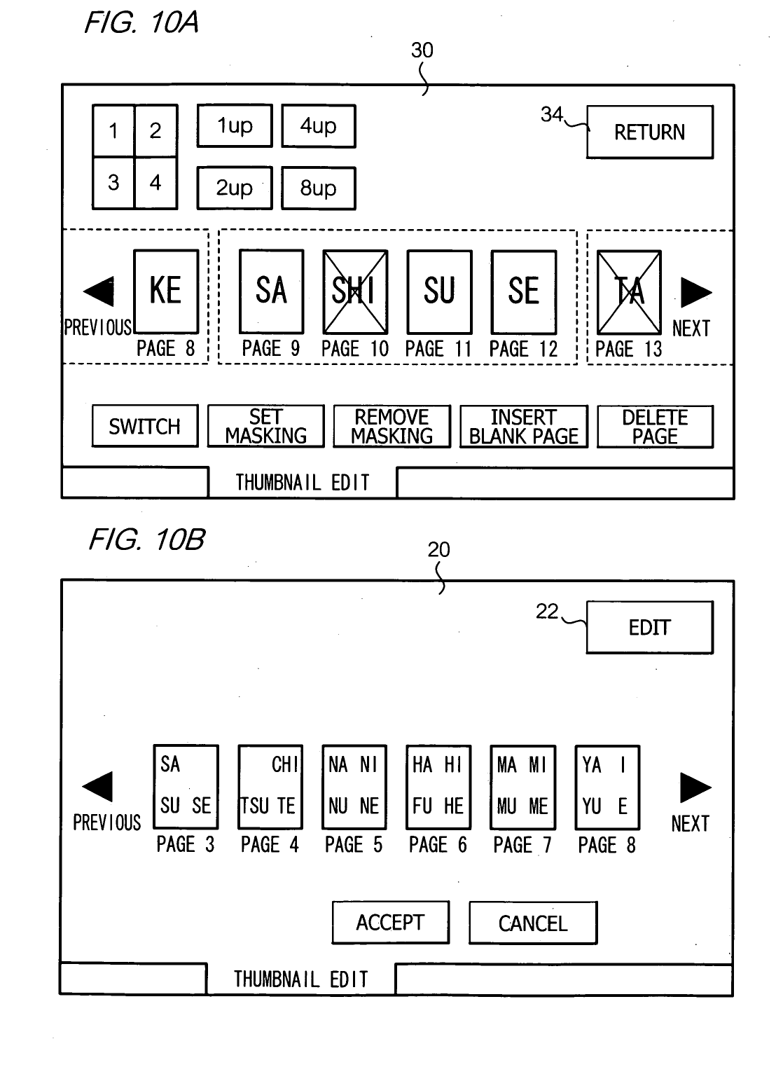

FIG. 11A shows an example of the thumbnail edit screen 30 after designation of the pre-combine thumbnail images targeted for masking removal. In the example of FIG. 11A, of the pre-combine thumbnail images “shi” and “ta” to be masked, the masking of “shi” is removed.

When the property information of the pre-combine thumbnail images is updated, the CPU 110 updates the N-up thumbnail images according to the updated property information of the pre-combine thumbnail images. That is, the CPU 110 changes the partitions of the N-up thumbnail images that correspond to the pre-combine thumbnail images whose flag indicating that they are to be subjected to masking is deleted, from an image having masking to the corresponding pre-combine thumbnail image.

FIG. 11B shows an example of the thumbnail display screen 20 for removing masking. When the user touches the position on the thumbnail edit screen 30 where the return key 34 is displayed, the CPU 110 displays the updated N-up thumbnail image on the thumbnail display screen 20. When the user touches the position on the thumbnail display screen 20 where the cancel key 26 is displayed, the CPU 110 reverts the changes to their original condition according to the change history stored in the memory 120. When the user touches the position on the thumbnail display screen 20 where the accept key 25 is displayed, the CPU 110 accepts the changes. That is, CPU 110 stores the changed N-up thumbnail images and the property information of the N-up thumbnail images in the HDD 138.

3-5. Inserting a Blank Page

When the user touches the position on the thumbnail edit screen 30 shown in FIG. 6, for example, where the blank page insert key 39 is displayed, the CPU 110 enters standby for the input of pre-combine thumbnail images to be replaced by a blank page. The user selects pre-combine thumbnail images to be replaced by a blank page by touching, in order, the display positions of the pre-combine thumbnail images to be replaced by a blank page. The CPU 110 adds a flag to the pre-combine thumbnail images that are selected. The flag indicates that a blank page is to be inserted. The CPU 110 increases the page number of the property information by one number at a time. The page number is included in the property information of the pre-combine thumbnail images whose page number is located behind the pre-combine thumbnail images to which a flag is added to indicate that a blank page is to be inserted there. The CPU 110 adds blank page (empty page) pre-combine thumbnail images. The CPU 110 adds property information that includes the same page number as the page number of the pre-combine thumbnail images replaced by a blank page to the blank page pre-combine thumbnail images that are added. The CPU 110 updates the display of the thumbnail edit screen 30 according to the updated property information.

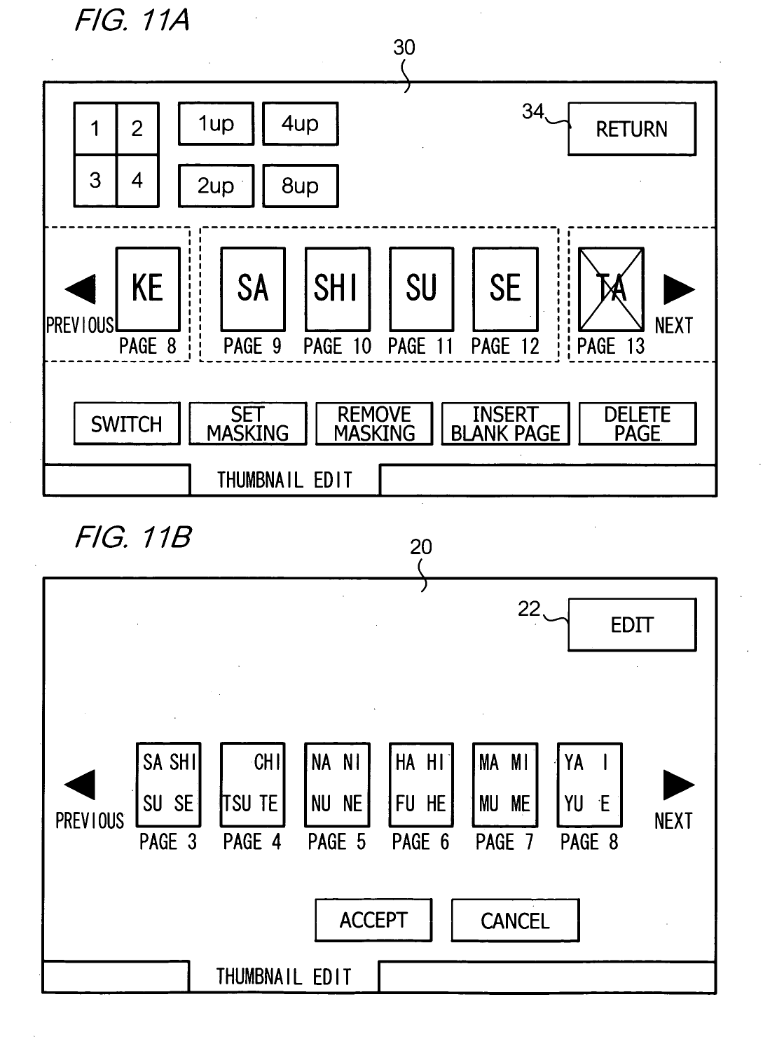

FIG. 12A shows an example of the thumbnail edit screen 30 for the empty pages adding process. In the example of FIG. 12A, the pre-combine thumbnail image of page 12 “se” is selected as the target for adding a blank page. That is, the CPU 110 updates the property information relating to the page number, of the property information of the pre-combine thumbnail image “se,” from “page 12” to “page 13.” The CPU 110 also increases the page number of the pre-combine thumbnail images having property information whose page number is behind the pre-combine thumbnail image “se.”

The CPU 110 then reassigns the identifiers specifying the N-up thumbnail images according to the updated page numbers. The CPU 110 reassigns the identifiers specifying the N-up thumbnail images in order from the pre-combine thumbnail images corresponding to the N-up thumbnail image that corresponds to the pre-combine thumbnail images where a blank page is inserted. The property information of the pre-combine thumbnail images “sa,” “shi,” “su” and the blank page are updated to correspond to the thumbnail image S1. Similarly, the property information of the pre-combine thumbnail images “se,” “ta,” “chi,” and “tsu” are updated to correspond to the thumbnail image S2. It is to be noted that in order to revert the changes back to the original condition in step S218, a change history may be stored in the memory 120.

When the property information of the pre-combine thumbnail images is updated, the CPU 110 updates the N-up images and the N-up thumbnail images according to the updated property information of the pre-combine thumbnail images. The pre-combine thumbnail images corresponding to the N-up thumbnail image S1 are updated to “sa,” “shi,” “su,” and a blank page in that order from the upper left. The pre-combine thumbnail images corresponding to the N-up thumbnail image S2 are updated to “se,” “ta,” “chi,” and “tsu” in that order from the upper left. The CPU 110 first updates the N-up images corresponding to the N-up thumbnail images to which changes are made. That is, the CPU 110 divides the N-up image into N partitions based on the layout information. The CPU 110 rearranges the divided images according to the property information. The CPU 110 combines the rearranged images to generate an N-up image. The CPU 110 generates N-up thumbnail images from the N-up images.

FIG. 12B shows an example of the thumbnail display screen 20 for the blank page addition process. When the user touches the position on the thumbnail edit screen 30 where the return key 34 is displayed, the CPU 110 displays the updated N-up thumbnail image on the thumbnail display screen 20. When the user touches the position on the thumbnail display screen 20 where the cancel key 26 is displayed, the CPU 110 reverts the changes to their original condition in accordance with the change history stored in the memory 120. When the user touches the position on the thumbnail display screen 20 where the accept key 25 is displayed, the CPU 110 accepts the changes. That is, CPU 110 stores the changed N-up images, N-up thumbnail images, and the property information of the N-up thumbnail images in the HDD 138.

3-6. Deleting a Page

When the user touches the position on the thumbnail edit screen 30 shown in FIG. 6, for example, where the page delete key 40 is displayed, the CPU 110 enters standby for the input of pre-combine thumbnail images to be deleted. The user selects pre-combine thumbnail images to be targeted for deletion by touching, in order, the display positions of the pre-combine thumbnail images. The CPU 110 adds a flag to the pre-combine thumbnail images that are selected. The flag indicates that they are targeted for deletion. The CPU 110 then deletes the pre-combine thumbnail images that are targeted for deletion. The CPU 110 decreases the page number of the property information by one at a time, of the pre-combine thumbnail images whose page number is located behind the pre-combine thumbnail images to which the flag indicating the page targeted for deletion is added. The CPU 110 updates the display of the thumbnail edit screen 30 in accordance with the updated property information.

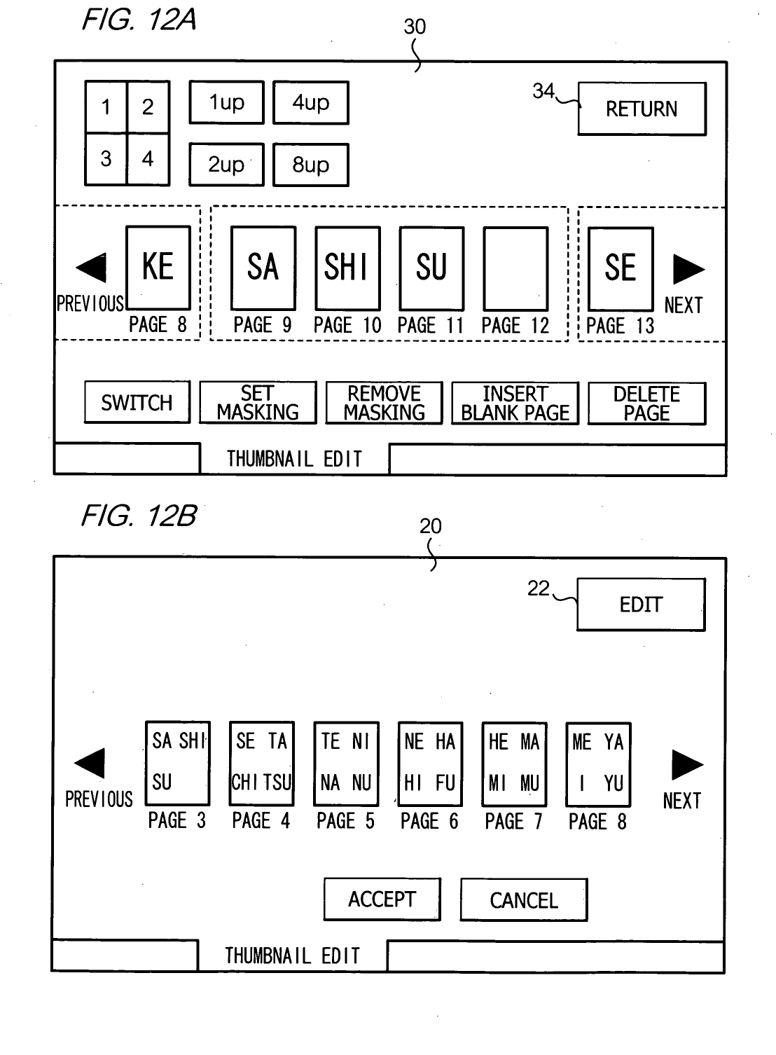

FIG. 13A shows an example of the thumbnail edit screen 30 for the page delete process. In the example of FIG. 13A, the pre-combine thumbnail images “sa” and “shi” are selected as targets for page deletion. That is, the CPU 110 deletes the pre-combine thumbnail image “sa” and “shi.” The CPU 110 updates the property information pertaining to the page number of the pre-combine thumbnail image “su,” which is located after the pre-combine thumbnail image “sa,” from “page 11” to “page 9.” The CPU 110 also decreases the page number of the pre-combine thumbnail images having property information whose page number is behind the pre-combine thumbnail image “su” by two numbers at a time (because two pages were deleted).

The CPU 110 then reallocates the identifiers specifying the N-up thumbnail images according to the updated page numbers. The CPU 110 reallocates the identifiers specifying the N-up thumbnail images in order from the pre-combine thumbnail images corresponding to the N-up thumbnail image that corresponds to the pre-combine thumbnail images targeted for deletion. The property information of the pre-combine thumbnail images “su,” “se,” “ta,” and “chi” are updated to correspond to the thumbnail image S1. Similarly, the property information of the pre-combine thumbnail images “tsu,” “te,” “na,” and “ni” are updated to correspond to the thumbnail image S2. Similar operation may be applied to the other pre-combine thumbnail images as well. It is to be noted that in order to revert the changes back to the original condition in step S218, a change history ma be stored in the memory 120.

When the property information of the pre-combine thumbnail images is updated, the CPU 110 updates the N-up images and the N-up thumbnail images according to the updated property information of the pre-combine thumbnail images. The pre-combine thumbnail images corresponding to the N-up thumbnail image S1 are changed to “su,” “se,” “ta,” and “chi” in that order from the upper left. The pre-combine thumbnail images corresponding to the N-up thumbnail image S2 are changed to “tsu,” “te,” “na,” and “ni” in that order from the upper left. The CPU 110 first updates the N-up images corresponding to the N-up thumbnail images to which changes are made. That is, the CPU 110 divides the N-up image into N partitions based on the layout information. The CPU 110 rearranges those divided images according to the property information. The CPU 110 then combines the rearranged images to generate the N-up images. The CPU 110 generates N-up thumbnail images from the N-up images.

FIG. 13B shows an example of the thumbnail display screen 20 for the page deletion process. When the user touches the position on the thumbnail edit screen 30 where the return key 34 is displayed, the CPU 110 displays the updated N-up thumbnail images on the thumbnail display screen 20. When the user touches the position on the thumbnail display screen 20 where the cancel key 26 is displayed, the CPU 110 reverts the changes to their original condition in accordance with the change history stored in the memory 120. When the user touches the position on the thumbnail display screen 20 where the accept key 25 is displayed, the CPU 110 accepts the changes. That is, CPU 110 stores the changed N-up images, N-up thumbnail images, and the property information of the N-up thumbnail images in the HDD 138.

Thus, as described above, according to the present embodiment, it is possible to search and edit N-up images.

### 4. Further Embodiments

The present invention is not limited to the foregoing embodiment, and can be modified in various ways.

The foregoing embodiment was described with regard to an implementation in which, when reading and digitizing the original document, a carrying device such as an ADF was used to read the original document sequentially one page at a time. However, the method for reading the original document is not limited to this. For example, the present invention also can be adopted when reading an original document image that already is in an N-up condition, such as the case of scanning two pages of an open book simultaneously.

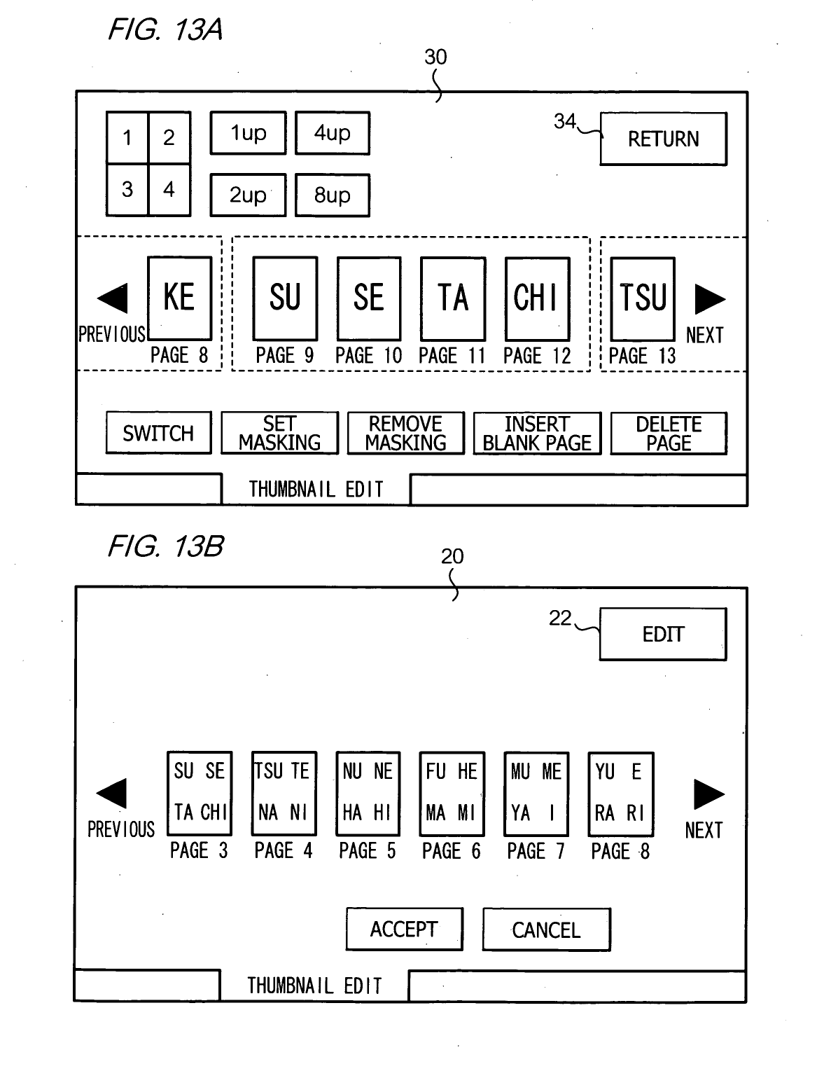

FIG. 14 shows an example of a control screen according to another embodiment. The control screen shown in FIG. 14 is displayed on the liquid crystal touch panel 2. The following description is with regard to scanning a book that is open, that is, in the 2-up state. The user selects the appropriate N-up number according to the original document. In this embodiment, the user touches the position where to the “2-up” key is displayed, selecting N=2. The user then operates the liquid crystal touch panel 2 to designate an input size and a save size. If the original document is placed on the platen glass to perform reading without using an ADF, then the user touches the position where the “platen” key is displayed. By doing this, the multi function device 100 reads original document placed on the platen without using the ADF.

When the original document is read and digitized, the CPU 110 first saves the data that are read as an N-up image. The CPU 110 then reduces the N-up image at a predetermined reduction ratio, obtaining an N-up thumbnail image. The CPU 110 then divides the N-up image into N partitions according to the value of N that is designated by the user, obtaining pre-combine reduced images. The CPU 110 reduces the pre-combine reduced images by a predetermined reduction ration, obtaining pre-combine thumbnail images. The CPU 110 adds property information indicating the identifier, page number, and corresponding N-up thumbnail image, for example, to each N-up image, N-up thumbnail image, and pre-combine thumbnail image. The CPU 110 stores the N-up image, N-up thumbnail image, and pre-combine thumbnail images in the HDD 138 along with the property information.

As described above, the invention provides an image reading device, including: an image reading unit that reads input images and digitizes the input images, the input images including a plurality of pages, the plurality of pages being digitized one by one; a parameter designating unit that designates a parameter that defines a reduction ratio a (where a is a positive real number), a parameter that defines a number N for combining the reduced images, and a parameter that defines a layout of the reduced images; an image reducing unit that generates pre-combine reduced images, the pre-combine reduced images being generated by reducing the input images in accordance with the reduction ratio a designated by the parameter designating unit; a pre-combine thumbnail image generating unit that generates pre-combine thumbnail images, the pre-combine thumbnail images being generated by reducing the input images in accordance with a reduction ratio b (where b is a positive real number, and satisfies a>b); an N-up image generating unit that generates an N-up image, the N-up image being generated by combining N-number of the pre-combine reduced images, the N-number of the pre-combine reduced images being combined in a layout defined by the parameters, the parameters being designated by the parameter designating unit;

an N-up thumbnail image generating unit that generates an N-up thumbnail image, the N-up thumbnail image being generated by reducing the N-up image in accordance with a reduction ratio c (where c is a positive real number, and satisfies a>c); and a storage device that stores (1) the N-up image generated by the N-up image generating unit, (2) the N-up thumbnail image corresponding to the N-up image, generated by the N-up thumbnail image generating unit, (3) the N-number of pre-combine thumbnail images corresponding to the N-number of pre-combine reduced images included in the N-up image, generated by the pre-combine thumbnail image generating unit, and (4) layout information that indicates a layout of the pre-combine reduced images in the N-up image and is defined by the parameter designating unit.

The invention also provides an image reading device including: an image reading unit that reads an input image and digitizes the input image; a parameter designating unit that designates a parameter that defines a number of partitions N of the input image read by the image reading unit, and a parameter that defines a layout of the divided images; an image dividing unit that generates pre-combine reduced images, the pre-combine reduced images being generated by dividing the input image into N partitions, the input image being digitized by the image reading unit, the number N being defined by the parameters designated by the parameter designating unit; a pre-combine thumbnail image generating unit that generates pre-combine thumbnail images, the pre-combine thumbnail images being generated by reducing the pre-combine reduced images in accordance with a reduction ratio b (where b is a positive real number), the pre-combine reduced images being generated by the image dividing unit; an N-up thumbnail image generating unit that generates an N-up thumbnail image, the N-up thumbnail image being generated by reducing the input image in accordance with a reduction ratio c (where c is a positive real number); and a storage device that stores (1) the input image digitized by the image reading unit, (2) the N-up thumbnail image corresponding to the input image, generated by the N-up thumbnail image generating unit, (3) the N-number of pre-combine thumbnail images corresponding to the N-number of pre-combine reduced images included in the N-up image, generated by the pre-combine thumbnail image generating unit, and (4) layout information that indicates a layout of the pre-combine reduced images in the N-up image and is defined by the parameter designating unit.

Furthermore, the invention also provides an image processing device including: a storage device that stores (1) an N-up image obtained by combining N-pages of images into a single page after the images are reduced, (2) an N-up thumbnail image obtained by reducing the N-up image in accordance with a reduction ratio c (where c is a positive real number), (3) N-number of pre-combine thumbnail images obtained by reducing each of the N-pages of images included in the N-up image in accordance with a reduction ratio b (where b is a positive real number), and (4) property information including layout information that indicates a layout of the images in the N-up image.

In another embodiment, the image processing device may further include: an N-up image designating unit that designates one or a plurality of the N-up images stored in the storage unit; and a display unit that displays the pre-combine thumbnail images corresponding to the N-up image designated by the N-up image designating unit.

In another embodiment, the image processing device may further include: a thumbnail image designating unit that designates one or a plurality of the pre-combine thumbnail images displayed by the display unit; a property information changing unit that changing at least one of the property information corresponding to the pre-combine thumbnail image designated by the thumbnail image designating unit, and the property information of the N-up image corresponding to the pre-combine thumbnail image; and an image restructuring unit that restructures at least one of the N-up image and the N-up thumbnail image according to the property information changed by the property information changing unit.

In another embodiment, the property information of the pre-combine thumbnail image may includes a page number showing the ordering of the pages; the thumbnail image designating unit designates two thumbnail images; and the property information changing unit exchanges the page numbers of the pre-combine thumbnail images that are designated by the thumbnail image designating unit.

In another embodiment, the property information of the pre-combine thumbnail images may include a masking process flag that indicates whether display in the N-up thumbnail image is allowed; the property information changing unit changes the masking process flag to indicate that display is not allowed, the masking process flag corresponding to the pre-combine thumbnail image designated by the thumbnail image designating unit; and the image restructuring unit may replace a region with a predetermined image, the region corresponding to the pre-combine thumbnail image in the N-up thumbnail image, the N-up thumbnail image corresponding to the pre-combine thumbnail image whose masking process flag is changed.

In another embodiment, the property information of the pre-combine thumbnail images may include a masking process flag that indicates whether display in the N-up thumbnail image is allowed; the property information changing unit may change the masking process flag to indicate that display is allowed, the masking process flag corresponding to the pre-combine thumbnail image designated by the thumbnail image designating unit; and the image restructuring unit may replace the image of a region with the pre-combine thumbnail image, the region corresponding to the pre-combine thumbnail image in the N-up thumbnail image, the N-up thumbnail image corresponding to the pre-combine thumbnail image whose masking process flag is changed.

In another embodiment, the property information of the pre-combine thumbnail images may include a page number showing the ordering of the pages; the thumbnail image designating unit designates two pre-combine thumbnail images whose page numbers are adjacent; the property information changing unit may increase by one the page number of the pre-combine thumbnail image, the pre-combine thumbnail image being one of the two pre-combine thumbnail images designated by the thumbnail image designating unit, whose page number is larger; and the image restructuring unit may insert a pre-combine thumbnail image corresponding to a blank page between the two pre-combine thumbnail images designated by the thumbnail image designating unit.

In another embodiment, the image restructuring unit may delete the pre-combine thumbnail images designated by the thumbnail image designating unit.

Furthermore, the invention also provides an image reading method, including: reading input images and digitizing the input images, the input images including a plurality of pages, the plurality of pages being digitized one by one; designating a parameter that defines a reduction ratio a (where a is a positive real number), a parameter that defines a number N for combining the reduced images, and a parameter that defines a layout of the reduced images; generating pre-combine reduced images, the pre-combine reduced images being generated by reducing the input images in accordance with the reduction ratio a; generating pre-combine thumbnail images, the pre-combine thumbnail images being generated by reducing the input images in accordance with a reduction ratio b (where b is a positive real number, and satisfies a>b); generating an N-up image, the N-up image being generated by combining N-number of the pre-combine reduced images, the N-number of the pre-combine reduced images being combined in a layout defined by the parameters; generating an N-up thumbnail image, the N-up thumbnail image being generated by reducing the N-up image in accordance with a reduction ratio c (where c is a positive real number, and satisfies a>c); and storing (1) the N-up image, (2) the N-up thumbnail image corresponding to the N-up image, (3) the N-number of pre-combine thumbnail images corresponding to the N-number of pre-combine reduced images included in the N-up image, and (4) layout information that indicates a layout of the pre-combine reduced images in the N-up image.

Furthermore, the invention also provides an image reading method, including: reading an input image and digitizing the input image; designating a parameter that defines a number of partitions N of the input image, and a parameter that defines a layout of the divided images; generating pre-combine reduced images, the pre-combine reduced images being generated by dividing the input image into N partitions, the number N being defined by the parameter; generating pre-combine thumbnail images, the pre-combine thumbnail images being generated by reducing the pre-combine reduced images in accordance with a reduction ratio b (where b is a positive real number); generating an N-up thumbnail image, the N-up thumbnail image being generated by reducing the input image in accordance with a reduction ratio c (where c is a positive real number); and storing (1) the input image, (2) the N-up thumbnail image corresponding to the input image, (3) the N-number of pre-combine thumbnail images corresponding to the N-number of pre-combine reduced images included in the N-up image, and (4) layout information that indicates a layout of the pre-combine reduced images in the N-up image.

Furthermore, the invention also provides an image processing method, in an image processing device having a storage device that stores (1) an N-up image obtained by combining N-pages of images into a single page after the images are reduced, (2) an N-up thumbnail image obtained by reducing the N-up image in accordance with a reduction ratio c (where c is a positive real number), (3) N-number of pre-combine thumbnail images obtained by reducing each of the N-pages of images included in the N-up image in accordance with a reduction ratio b (where b is a positive real number), and (4) property information including layout information that indicates a layout of the images in the N-up image, the image processing method including: designating one or a plurality of the N-up images stored in the storage device; displaying the pre-combine thumbnail images corresponding to the N-up image; designating one or a plurality of the pre-combine thumbnail images that are displayed; changing at least one of the property information of the designated pre-combine thumbnail image, the property information of the N-up thumbnail image corresponding to that pre-combine thumbnail image, and the property information of the N-up image corresponding to the pre-combine thumbnail image; and restructuring at least one of the N-up image and the N-up thumbnail image according to the changed property information.

The foregoing description of the embodiments of the present invention is provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosures of Japanese Patent Applications No. 2005-274438 filed on Sep. 21, 2005, including specification, claims, drawings and abstract are incorporated herein by reference in its entirety.

What is claimed is:

1. An image reading device, comprising:
an image reading unit that reads input images and digitizes the input images, the input images including a plurality of pages, the plurality of pages being digitized one by one;
a parameter designating unit that designates a parameter that defines a reduction ratio a (where a is a positive real number), a parameter that defines a number N for combining the reduced images, and a parameter that defines a layout of the reduced images;
an image reducing unit that generates pre-combine reduced images, the pre-combine reduced images being generated by reducing the input images in accordance with the reduction ratio a designated by the parameter designating unit;
a pre-combine thumbnail image generating unit that generates pre-combine thumbnail images, the pre-combine thumbnail images being generated by reducing the input images in accordance with a reduction ratio b (where b is a positive real number, and satisfies a>b);
an N-up image generating unit that generates an N-up image, the N-up image being generated by combining N-number of the pre-combine reduced images, the N-number of the pre-combine reduced images being combined in a layout defined by the parameters, the parameters being designated by the parameter designating unit;
an N-up thumbnail image generating unit that generates an N-up thumbnail image, the N-up thumbnail image being generated by reducing the N-up image in accordance with a reduction ratio c (where c is a positive real number, and satisfies a>c); and
a storage device that stores (1) the N-up image generated by the N-up image generating unit, (2) the N-up thumbnail image corresponding to the N-up image, generated by the N-up thumbnail image generating unit, (3) the N-number of pre-combine thumbnail images corresponding to the N-number of pre-combine reduced images included in the N-up image, generated by the pre-combine thumbnail image generating unit, and (4) layout information that indicates a layout of the pre-combine reduced images in the N-up image and is defined by the parameter designating unit.

2. An image reading device, comprising:
an image reading unit that reads an input image and digitizes the input image;
a parameter designating unit that designates a parameter that defines a number of partitions N of the input image read by the image reading unit, and a parameter that defines a layout of the divided images;
an image dividing unit that generates pre-combine reduced images, the pre-combine reduced images being generated by dividing the input image into N partitions, the input image being digitized by the image reading unit, the number N being defined by the parameters designated by the parameter designating unit;
a pre-combine thumbnail image generating unit that generates pre-combine thumbnail images, the pre-combine thumbnail images being generated by reducing the pre-combine reduced images in accordance with a reduction ratio b (where b is a positive real number), the pre-combine reduced images being generated by the image dividing unit;
an N-up thumbnail image generating unit that generates an N-up thumbnail image, the N-up thumbnail image being generated by reducing the input image in accordance with a reduction ratio c (where c is a positive real number); and
a storage device that stores (1) the input image digitized by the image reading unit, (2) the N-up thumbnail image corresponding to the input image, generated by the N-up thumbnail image generating unit, (3) the N-number of pre-combine thumbnail images corresponding to the N-number of pre-combine reduced images included in the N-up image, generated by the pre-combine thumbnail image generating unit, and (4) layout information that indicates a layout of the pre-combine reduced images in the N-up image and is defined by the parameter designating unit.

3. An image processing device, comprising:
a storage device that stores (1) an N-up image obtained by combining N-pages of images into a single page after the images are reduced, (2) an N-up thumbnail image obtained by reducing the N-up image in accordance with a reduction ratio c (where c is a positive real number), (3) N-number of pre-combine thumbnail images obtained by reducing each of the N-pages of images included in the N-up image in accordance with a reduction ratio b (where b is a positive real number), and (4) property information including layout information that indicates a layout of the images in the N-up image.

4. The image processing device according to claim 3, further comprising:
an N-up image designating unit that designates one or a plurality of the N-up images stored in the storage unit; and
a display unit that displays the pre-combine thumbnail images corresponding to the N-up image designated by the N-up image designating unit.

5. The image processing device according to claim 4, further comprising:
a thumbnail image designating unit that designates one or a plurality of the pre-combine thumbnail images displayed by the display unit;
a property information changing unit that changing at least one of the property information corresponding to the pre-combine thumbnail image designated by the thumbnail image designating unit, and the property information of the N-up image corresponding to the pre-combine thumbnail image; and
an image restructuring unit that restructures at least one of the N-up image and the N-up thumbnail image according to the property information changed by the property information changing unit.

6. The image processing device according to claim 5,
wherein the property information of the pre-combine thumbnail image includes a page number showing the ordering of the pages;
the thumbnail image designating unit designates two thumbnail images; and
the property information changing unit exchanges the page numbers of the pre-combine thumbnail images that are designated by the thumbnail image designating unit.

7. The image processing device according to claim 5,
wherein the property information of the pre-combine thumbnail images includes a masking process flag that indicates whether display in the N-up thumbnail image is allowed;
the property information changing unit changes the masking process flag to indicate that display is not allowed, the masking process flag corresponding to the pre-combine thumbnail image designated by the thumbnail image designating unit; and
the image restructuring unit replaces a region with a predetermined image, the region corresponding to the pre-combine thumbnail image in the N-up thumbnail image, the N-up thumbnail image corresponding to the pre-combine thumbnail image whose masking process flag is changed.

8. The image processing device according to claim 5,
wherein the property information of the pre-combine thumbnail images includes a masking process flag that indicates whether display in the N-up thumbnail image is allowed;
the property information changing unit changes the masking process flag to indicate that display is allowed, the masking process flag corresponding to the pre-combine thumbnail image designated by the thumbnail image designating unit; and
the image restructuring unit replaces the image of a region with the pre-combine thumbnail image, the region corresponding to the pre-combine thumbnail image in the N-up thumbnail image, the N-up thumbnail image corresponding to the pre-combine thumbnail image whose masking process flag is changed.

9. The image processing device according to claim 5,
wherein the property information of the pre-combine thumbnail images includes a page number showing the ordering of the pages;
the thumbnail image designating unit designates two pre-combine thumbnail images whose page numbers are adjacent;
the property information changing unit increases by one the page number of the pre-combine thumbnail image, the pre-combine thumbnail image being one of the two pre-combine thumbnail images designated by the thumbnail image designating unit, whose page number is larger; and
the image restructuring unit inserts a pre-combine thumbnail image corresponding to a blank page between the two pre-combine thumbnail images designated by the thumbnail image designating unit.

10. The image processing device according to claim 5,
wherein the image restructuring unit deletes the pre-combine thumbnail images designated by the thumbnail image designating unit.

11. An image reading method, comprising:
reading input images and digitizing the input images, the input images including a plurality of pages, the plurality of pages being digitized one by one;
designating a parameter that defines a reduction ratio a (where a is a positive real number), a parameter that defines a number N for combining the reduced images, and a parameter that defines a layout of the reduced images;
generating pre-combine reduced images, the pre-combine reduced images being generated by reducing the input images in accordance with the reduction ratio a;
generating pre-combine thumbnail images, the pre-combine thumbnail images being generated by reducing the input images in accordance with a reduction ratio b (where b is a positive real number, and satisfies a>b);
generating an N-up image, the N-up image being generated by combining N-number of the pre-combine reduced images, the N-number of the pre-combine reduced images being combined in a layout defined by the parameters;
generating an N-up thumbnail image, the N-up thumbnail image being generated by reducing the N-up image in accordance with a reduction ratio c (where c is a positive real number, and satisfies a>c); and
storing (1) the N-up image, (2) the N-up thumbnail image corresponding to the N-up image, (3) the N-number of pre-combine thumbnail images corresponding to the N-number of pre-combine reduced images included in the N-up image, and (4) layout information that indicates a layout of the pre-combine reduced images in the N-up image.

12. An image reading method, comprising:
reading an input image and digitizing the input image;
designating a parameter that defines a number of partitions N of the input image, and a parameter that defines a layout of the divided images;
generating pre-combine reduced images, the pre-combine reduced images being generated by dividing the input image into N partitions, the number N being defined by the parameter;
generating pre-combine thumbnail images, the pre-combine thumbnail images being generated by reducing the pre-combine reduced images in accordance with a reduction ratio b (where b is a positive real number);
generating an N-up thumbnail image, the N-up thumbnail image being generated by reducing the input image in accordance with a reduction ratio c (where c is a positive real number); and
storing (1) the input image, (2) the N-up thumbnail image corresponding to the input image, (3) the N-number of pre-combine thumbnail images corresponding to the N-number of pre-combine reduced images included in the N-up image, and (4) layout information that indicates a layout of the pre-combine reduced images in the N-up image.

13. An image processing method, in an image processing device having a storage device that stores (1) an N-up image obtained by combining N-pages of images into a single page after the images are reduced, (2) an N-up thumbnail image obtained by reducing the N-up image in accordance with a reduction ratio c (where c is a positive real number), (3) N-number of pre-combine thumbnail images obtained by reducing each of the N-pages of images included in the N-up image in accordance with a reduction ratio b (where b is a positive real number), and (4) property information including layout information that indicates a layout of the images in the N-up image, the image processing method comprising:
designating one or a plurality of the N-up images stored in the storage device;
displaying the pre-combine thumbnail images corresponding to the N-up image;
designating one or a plurality of the pre-combine thumbnail images that are displayed;
changing at least one of the property information of the designated pre-combine thumbnail image, the property information of the N-up thumbnail image corresponding to that pre-combine thumbnail image, and the property information of the N-up image corresponding to the pre-combine thumbnail image; and
restructuring at least one of the N-up image and the N-up thumbnail image according to the changed property information.
